(19) United States
(12) Patent Application Publication
(10) Pub. No.: US 2018/0148181 A1
(43) Pub. Date: May 31, 2018

(54) AIR DISTRIBUTION MANIFOLD WITH INTEGRAL MULTIZONE TEC TRIM SYSTEM

(71) Applicant: Hamilton Sundstrand Corporation, Windsor Locks, CT (US)

(72) Inventor: Donald E. Army, Enfield, CT (US)

(21) Appl. No.: 15/364,849

(22) Filed: Nov. 30, 2016

(51) Int. Cl. B64D 13/08; F25B 21/02

(52) U.S. Cl. CPC B64D 13/08; B64D 2013/0603; F25B 21/02

(57) ABSTRACT

A system for distributing air to a plurality of aircraft zones includes an air mixer including an air inlet plenum and a manifold. The manifold including a plurality of sections fluidly coupled to the plurality of aircraft zones. At least one thermoelectric device is associated with said plurality of sections of said manifold. The at least one thermoelectric device is operable to condition air within said plurality of sections to a desired temperature corresponding to the plurality of aircraft zones.

### BACKGROUND

Embodiments of the disclosure related to environmental control systems of an aircraft, and more particularly, to an air distribution system for providing air having different temperatures to different zones within an aircraft.

In most aircraft, an air conditioning system is used to condition the aircraft cabin, the cockpit, and equipment within compartments such as the cargo bay or the avionics bay. In an air conditioning system having multiple zones, the actual temperature within each zone may vary. To account for these variations in temperature, conventional air conditioning systems include a trim valve dedicated to each zone for trimming cool conditioned air to create an air flow at the correct temperature for each particular zone. Control logic of the system typically determines which zone requires the coolest temperature air and uses that requirement to set the reference temperature at which the cool conditioned air is provided. The other zones of the system will use the trim valves associated therewith to mix hot air, for example bled from an engine of the aircraft, with the cool conditioned air to create a combined air flow at the proper temperature for each respective zone.

Conventional trim systems include a variety of components which add both weight and complexity to the aircraft. Further, the noise generated as the air rushes through the trim valve of each section negatively affects the ride quality for passengers on the aircraft.

### BRIEF DESCRIPTION

According to an embodiment, a system for distributing air to a plurality of aircraft zones includes an air mixer including an air inlet plenum and a manifold. The manifold including a plurality of sections fluidly coupled to the plurality of aircraft zones. At least one thermoelectric device is associated with said plurality of sections of said manifold. The at least one thermoelectric device is operable to condition air within said plurality of sections to a desired temperature corresponding to the plurality of aircraft zones.

According to another embodiment, a method of distributing air to a plurality of aircraft zones includes providing conditioned air to a plurality of sections of a manifold. The temperature of said conditioned air within each of said plurality of sections is trimmed using at least one thermoelectric device associated with said manifold.

### BRIEF DESCRIPTION OF THE DRAWINGS

The following descriptions should not be considered limiting in any way. With reference to the accompanying drawings, like elements are numbered alike:

FIG. 1 is a schematic diagram of an example of an aircraft having a plurality of zones associated with an air distribution system;

FIG. 2 is a schematic diagram of an air distribution system according to an embodiment; and

FIG. 3 is a schematic diagram of another air distribution system according to an embodiment.

### DETAILED DESCRIPTION

A detailed description of one or more embodiments of the disclosed apparatus and method are presented herein by way of exemplification and not limitation with reference to the Figures.

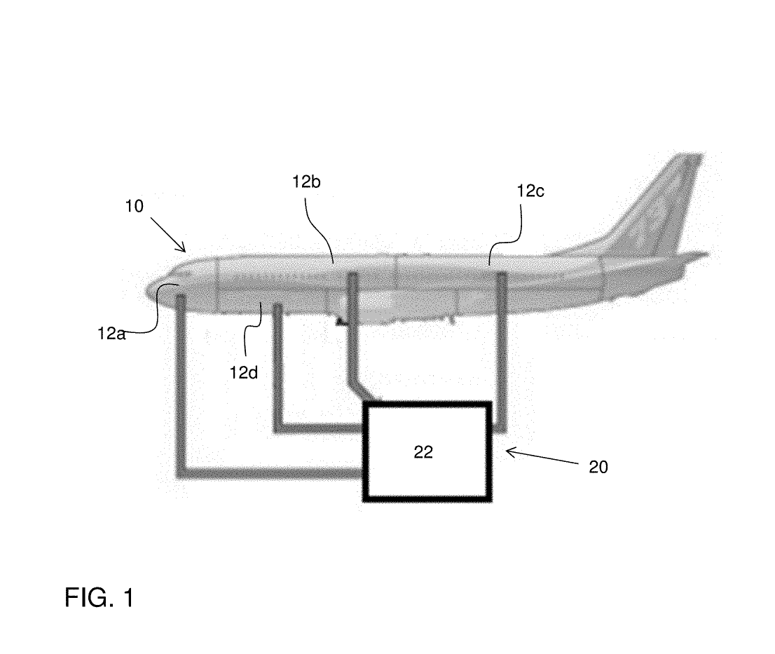

With reference now to FIG. 1, an example of an aircraft 10 is illustrated. The aircraft 10 is typically divided into several zones 12 with respect to an air conditioning system used to cool the aircraft 10. In the illustrated, non-limiting embodiment, the aircraft 10 includes four distinct zones 12. The cockpit of the aircraft 10 is a first zone 12a, the main cabin of the aircraft 10 is divided into a second and third zone 12b, 12c, and an avionics bay is a fourth zone 12d. However, any configuration of an aircraft 10 having any number of zones 12 is contemplated herein. A system 20 is configured to distribute conditioned air having a desired temperature to each of the plurality of zones 12 of the aircraft 10.

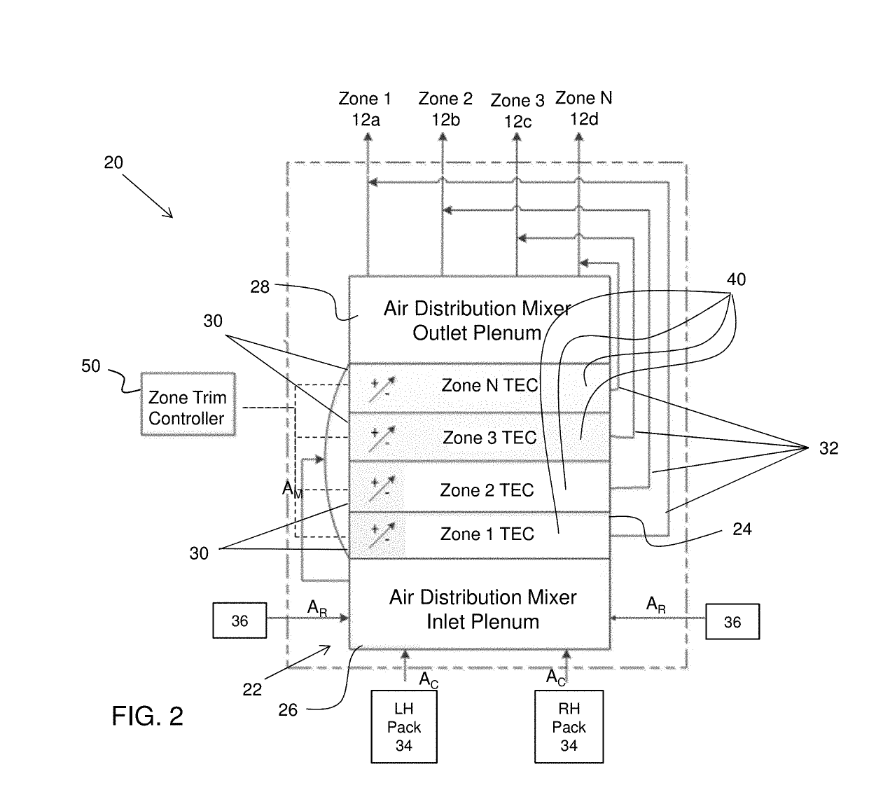

With reference to the FIG. 2, the system 20 for distributing conditioned air is shown in more detail. The system 20 includes an air distribution mixer 22 having a manifold 24, an inlet plenum 26 and an outlet plenum 28. As shown, the manifold 24 may be divided into a plurality of sections 30. In an embodiment, air is configured to flow from the inlet plenum 26 into each of the plurality of sections 30 of the manifold 24 in parallel. Alternatively, air from the inlet plenum 26 may be configured to flow through each of the plurality of sections 30 of the manifold 24 sequentially. A duct 32 is arranged in fluid communication with each section 30 of the manifold 24. In an embodiment, each duct 32 is associated with and configured to supply conditioned air having a desired temperature from a section 30 of the manifold 24 to a respective zone 12 of the aircraft.

The system 20 includes at least one of air conditioning pack 34 for producing fresh, conditioned air. Although two air conditioning packs 34 are shown in the FIG., a left air conditioning pack and a right air conditioning pack, it should be understood that an air distribution system 20 having a single air conditioning pack 34 or more than two air conditioning packs 34 are also within the scope of the disclosure. Each of the plurality of packs 34 is arranged in fluid communication with the air mixer inlet plenum 26 such that conditioned air, illustrated schematically as A_{C}, from the plurality of air conditioning packs 34 is supplied to the air mixer 22.

Alternatively or in addition, recirculation air, illustrated schematically as A_{R}, returned from a pressurized portion of the aircraft, such as from the passenger cabin, cockpit, or select cargo areas for example, is provided to the air mixer inlet plenum 26. One or more fans 36 may be used to deliver the recirculation air A_{R} to the air mixer 22 where it is mixed with the fresh air A_{C} from the air conditioning packs 34 prior to distribution to the plurality of zones 12. The mixture of recirculation air A_{R} and conditioned air A_{C} within the manifold 24 will be referred to herein as mixed air A_{M}.

The demand, specifically the temperature of each of the plurality of zones 12 of the aircraft 10 may be different. Unlike conventional systems where the correct temperature for each particular zone 12 is achieved by combining the cool mixed air A_{M} with hot air, such as air bled from an engine of the aircraft for example, an electrical device 40 is used to heat the mixed air A_{M} within the manifold 24 to achieve the correct temperature for each zone 12. In an embodiment, the electrical device 40 includes a thermoelectric device, for example a thermoelectric cooler (TEC) positioned between the inlet plenum 26 and the outlet plenum 28 of the manifold 24. However, it should be understood that other electrical devices capable of heating the air within the manifold 24 are also contemplated herein. After the air is heated by the electrical device 40, the air from each section 30 of the manifold 24 is provided to a corresponding zone 12 of the aircraft 10 via ducts 32.

The TEC 40 can include one or more thermoelectric elements that transfer thermal energy in a particular direction when electrical energy is applied to the one or more thermoelectric elements. For example, when electrical energy is applied using a first polarity, the TEC 40 transfers thermal energy in a first direction. Alternatively, when electrical energy having a second polarity, opposite the first polarity is applied, the TEC 40 transfers thermal energy in a second direction, opposite the first direction. Accordingly, the TEC 40 may be selectively operated to transfer heat to or removed heat from the adjacent fluid or medium. In an embodiment, the TEC 40 may be a superlattice device having multiple of layers of two or more materials.

In an embodiment, best shown in FIG. 2, each section 30 of the manifold 24 has an individual TEC 40 associated therewith to heat the air within the section 30 to a desired temperature. In such embodiments, each TEC 40 is sized based on the section 30 and/or the demands of the corresponding zone 12 of the aircraft 10. Accordingly, the TEC 40 associated with a first section 30 of the manifold 24 may have a different configuration than a TEC 40 associated with another section 30 of the manifold 24.

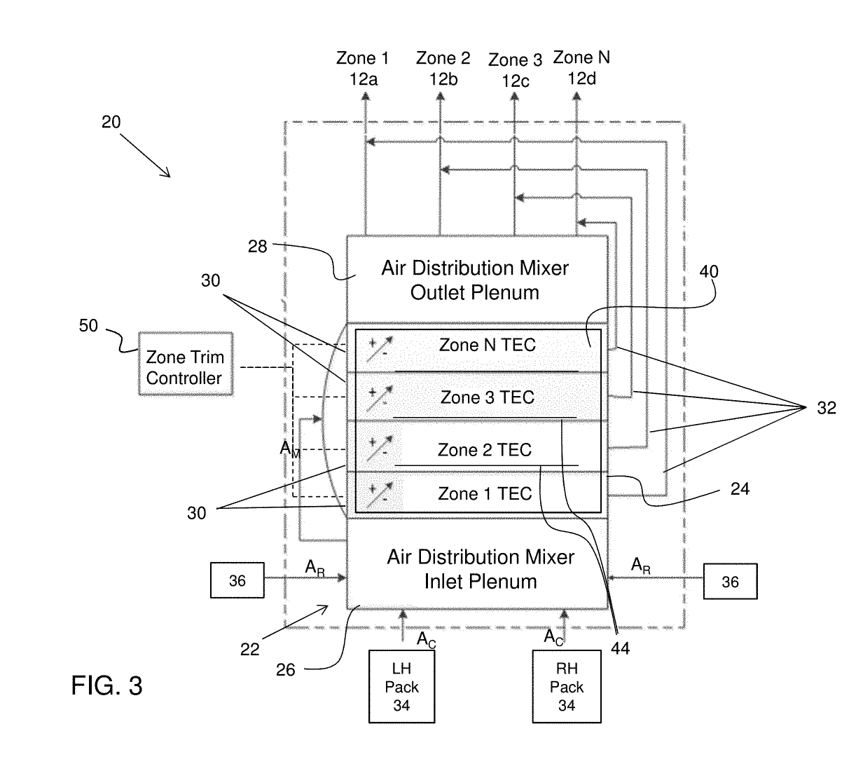

In another embodiment, illustrated in FIG. 3, a single TEC 40 having a plurality of zones 42 defined therein is associated with the manifold 24. The plurality of zones 42 may be formed by partitioning the TEC 40 using an orifice plate or other dividing mechanism 44. Each of the plurality of zones 42 of the TEC 40 is sized relative to the heating requirement of a respective one of the zones 12 of the aircraft 10. For example, in the illustrated, non-limiting embodiment, the TEC 40 includes four zones 42. A first zone 42a of the TEC 40 is fluidly connected to and sized to meet the heating requirements of the first aircraft zone 12a, a second zone 42b of the TEC 40 is fluidly connected to and sized to meet the heating requirements of the second aircraft zone 12b, a third zone 42c of the TEC 40 is fluidly connected to and sized to meet the heating requirements of the third aircraft zone 12c, and a fourth zone 42d of the TEC 40 is fluidly connected to and sized to meet the heating requirements of the fourth aircraft zone 12d.

A controller 50 is operably coupled to the at least one TEC 40. The controller can be an independent component, separable form the other system components. Alternatively, the controller may be integrated into another system controller or a centralized aircraft computer (not shown) of the aircraft. The controller 50 is programmed to control operation of the at least one TEC 40 based on the thermal demands of each of the aircraft zones 12. For example, the controller 50 is configured to determine the necessary amount of heat output from the at least one TEC 40 and control not only the amount but the polarity of the current provided to the at least one TEC 40 to achieve a desired temperature associated with each zone 12. In combination, the controller and the at least one TEC operate to trim up or trim down the temperature of the mixed air within each section 30 of the manifold 24 by varying the power and polarity of each TEC 40, or alternatively, each zone 42 of the TEC 40 independently.

Use of at least one TEC 40 to trim the air within the air mixer 22 before distributing the air to one or more zones 12 of an aircraft 10 eliminates the pressure regulation and throttling noise associated with conventional trim systems. In addition, the use of a TEC 40 requires a smaller installation volume than a conventional trim system. The reduced space requirement is a result of eliminating conventional trim system hardware, such as pressure regulating valves, check valves, pressure sensors, trim valves, mufflers, bulkhead shrouds, structural penetrations, and structural reinforcement doublers for example. The eliminated trim system also includes ducts, along with duct couplings, hangers and supports, and trim injectors.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Also, in the drawings and the description, there have been disclosed embodiments of the invention and, although specific terms may have been employed, they are unless otherwise stated used in a generic and descriptive sense only and not for purposes of limitation, the scope of the invention therefore not being so limited. Moreover, the use of the terms first, second, etc. , do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A system for distributing air to a plurality of aircraft zones, comprising:
an air mixer including an air inlet plenum and a manifold, said manifold including a plurality of sections fluidly coupled to the plurality of aircraft zones;
at least one thermoelectric device associated with said plurality of sections of said manifold, said at least one thermoelectric device operable to condition air within said plurality of sections to a desired temperature corresponding to the plurality of aircraft zones.

2. The system of claim 1, wherein said desired temperature of said conditioned air provided to one of the plurality of aircraft zones is different than said desired temperature of said conditioned air provided to another of the plurality of aircraft zones.

3. The system of claim 1, wherein said plurality of sections of said manifold is coupled to said air inlet plenum in series.

4. The system of claim 1, wherein said plurality of sections of said manifold is coupled to said air inlet plenum in parallel.

5. The system of claim 1, wherein said at least one thermoelectric device defines a plurality of TEC zones, each of said plurality of TEC zones being associated with one of said plurality of sections of said manifold and sized based on a demand of a respective one of the plurality of aircraft zones.

6. The system of claim 5, wherein said at least one thermoelectric device includes a plurality of thermoelectric devices and each of said plurality of TEC zones is defined by one of said plurality of thermoelectric devices.

7. The system of claim 5, wherein said at least one thermoelectric device includes one or more partitions for defining said plurality of TEC zones.

8. The system of claim 5, further comprising a controller operable to control an amount and polarity of current provided to the at least one thermoelectric device.

9. The system of claim 8, wherein each of said plurality of TEC zones is independently controllable to condition air with each of said plurality of sections to a desired temperature.

10. The system of claim 1, wherein at least one of recirculation air and air from an air conditioning pack is provided to said air inlet plenum.

11. The system of claim 10, wherein a mixture of said recirculation air and said air from said air conditioning pack is provided to said plurality of sections of said manifold.

12. A method of distributing air to a plurality of aircraft zones comprising:
providing conditioned air to a plurality of sections of a manifold; and
trimming a temperature of said conditioned air within each of said plurality of sections using at least one thermoelectric device associated with said manifold.

13. The method of claim 12, wherein providing conditioned air to said plurality of sections of said manifold includes providing said conditioned air to said plurality of sections of said manifold in series.

14. The method of claim 11, wherein providing conditioned air to said plurality of sections of said manifold includes providing said conditioned air to said plurality of sections of said manifold in parallel.

15. The method of claim 11, further comprising mixing recirculation air and air from an air conditioning pack provided at an air inlet plenum to form said conditioned air.

16. The method of claim 11, wherein said at least one thermoelectric device defines a plurality of TEC zones, each of said plurality of TEC zones being associated with one of said plurality of sections of said manifold and sized based on a demand of a respective one of the plurality of aircraft zones.

17. The method of claim 16, wherein said plurality of TEC zones is independently controlled to condition air with each of said plurality of sections to a desired temperature.
